(19) United States
(12) Patent Application Publication
(10) Pub. No.: US 2021/0354327 A1
(43) Pub. Date: Nov. 18, 2021

(54) WEIGHT VARIATION METHOD AND SLICING MACHINE FOR ITS IMPLEMENTATION

(71) Applicant: TVI ENTWICKLUNG & PRODUKTION GMBH, Bruckmuehl (DE)

(72) Inventors: Martin MAYR, Eiselfing (DE); Thomas VOELKL, Bruckmuehl (DE)

(73) Assignee: TVI ENTWICKLUNG & PRODUKTION GMBH, Bruckmuehl (DE)

(21) Appl. No.: 17/318,090

(22) Filed: May 12, 2021

(30) Foreign Application Priority Data
May 12, 2020 (DE) 102020112864.9

(51) Int. Cl. B26D 7/26; B26D 7/32; B26D 7/06; B26D 7/30

(52) U.S. Cl. CPC B26D 7/2628; B26D 7/30; B26D 7/0616; B26D 7/32

(57) ABSTRACT

In order to maintain required average weight of an entire batch when slicing a loaf into slices and yet avoid underweighting individual slices, different reference weights are selected for critical areas depending on basic shape of the loaf, usually the two ends, than for the remaining area.

### CROSS-REFERENCE TO RELATED APPLICATION

This application claims priority to German Patent Application No. DE 102020112864.9 filed on May 12, 2020, the disclosure of which is incorporated in its entirety by reference herein.

### TECHNICAL FIELD

The invention relates to improving weight accuracy in the production of slices or portions of several slices which are as accurate as possible in weight by cutting the slices from a usually elongated food loaf, the cross section of which, however, varies more or less along its length in its original state, in particular a meat loaf made from fresh meat of a cow or pig.

### BACKGROUND

In the production of slices of exact weight and subsequent packing with nominal weight indicated on the package (=“fixed packing”) of
single slices (single-slice portion), any excess weight of each slice is a loss factor for the manufacturer, whereas in the case of
weight-accurate multi-slice portions, individual slices with underweight on the one hand and overweight on the other can be combined to form a weight-accurate portion by specifying a given nominal weight, and only the proportionally much lower overweight of the total multi-slice portion then represents a loss factor.

In order to be able to control the weight of the slices to be separated, the loaf is usually brought to a cross section which is as constant as possible over its length by pressing in the longitudinal direction and, if necessary, also in the transverse direction, usually in a forming tube which is open at the front and back but closed around its contour.

Then the pressed loaf is pushed forward by means of the longitudinal press stamp from the opposite open end face, the cutting end, of the forming tube by a defined feed distance, i.e., an overhang, usually until it comes into contact with pressure with a stop plate, and a slice is cut off directly at the front end face of the forming tube by means of a blade. The axial position of the blade relative to the forming tube and its front end face generally always remains unchanged.

It should be made clear that the feed distance automatically set on the machine for each slice, the so-called thickness adjustment, is usually somewhat greater than the set distance between the stop plate and the axial position of the blade, since the piece of the loaf projecting from the front of the forming tube expands laterally and the resulting projection of the advanced loaf from the forming tube becomes shorter. The actual slice thickness that the slice has after it is separated, i.e., after it is free to expand, is usually somewhat greater than the set distance and somewhat less than the thickness adjustment.

For the purposes of the present invention, a fixed correlation is assumed between the weight and thickness of both the slice and the entire loaf, and thus the weight and thickness of a slice are quasi-equated, for example correction weight and correction thickness are used quasi-synonymously, and are therefore also commonly referred to as correction value.

Before a loaf is sliced, the total volume and thus the total weight of the loaf pressed therein—with the cutting end closed—is automatically determined approximately by detecting the position of the longitudinal press stamp and, if applicable, the cross press stamp relative to the forming tube—in particular by determining the extension length of the respective stamp from a working cylinder—while a defined force, the measuring force, is applied to the press stamps. The measuring force preferably corresponds to the feed force with which the loaf is later pushed forward step by step out of the forming tube for the cutting of slices by means of the longitudinal press stamp.

From the total volume of the loaf and the cross section of the forming tube in the compressed state, it is possible to automatically calculate the nominal thickness which all the slices of this loaf would have to have in order to produce—in particular without remainder in the form of underweight slices—only slices whose weight corresponds at least to a predetermined nominal weight, for example the nominal weight indicated on the label of the individual packaged slice or a reference weight which may be somewhat higher than the nominal weight and which the manufacturer of the packages himself specifies internally.

However, there are a number of reasons why, despite adjustment the longitudinal position of the blade to such a position corresponding to the nominal thickness of a slice of the compressed loaf, the slices nevertheless do not have the nominal weight, in particular their weight lies outside a tolerance range, in particular below a tolerance lower limit of this tolerance range.

Such slices with a (slice) sub-weight below the tolerance lower limit are rejected in the production of weight-accurate single-slice portions and must be used elsewhere and therefore have a lower value.

In the production of multiple-slice portions of accurate weight, slices whose weight is below the target weight, in particular below the lower tolerance limit, can be used at least in part for combining with overweight individual slices within the portion.

According to the invention, however, the focus is on the production of single slice portions of exact weight, i.e., of slices, each of which is at or above, but as close as possible to, the selected nominal weight, in particular a reference weight defined internally by the manufacturer of the slices, in particular within an existing tolerance range, or at least above a tolerance lower limit, thus avoiding rejecting slices.

Often the following external, mostly legal, conditions apply to the sale of portions with an indicated nominal weight, on the basis of which—and not on the basis of the actual weight—the price indicated on the package is determined and often the manufacturer of the packages with the portions therein is also paid:

1. Condition:

The average of the actual weight of all produced portions of a batch with the same specified nominal weight must be above the nominal weight.

In the case of very large batches requiring more than one working day for slicing, this may also apply to the partial batches sliced on each individual working day.

2. Condition

The actual weight of each individual portion, i.e., in the case of single-slice portions of each individual slice, must be above an external, usually legal tolerance lower limit TU, which is, for example, 15 g below the nominal weight in the case of a nominal weight between 500 g and 1000 g. The actual weight of the slice must be below the nominal weight.

If the 2nd condition is violated, the corresponding portion is a reject; if the 1st condition is violated, the entire batch produced is a reject.

Optionally specified, manufacturer-internal condition:

As a 3rd condition:

As a third condition, the fulfillment of the first condition should often also be ob-served for partial batches, in particular within each individual loaf, in accordance with the invention.

Thus, the average of the actual weight of all slices produced from one loaf should be above the nominal weight.

According to the invention, the individual loaf does not necessarily have to be sliced without remainder, although this would be the ideal case.

### SUMMARY

It is therefore the task of the invention to provide a method and a device for slicing loaves into weight-accurate slices, in which ideally not a single slice has an actual weight outside the tolerance range, in particular below the tolerance lower limit.

This object can be solved when slicing in particular pressed, i.e., definedly formed, loaves—in particular by the described circumferentially closed forming tube, which has a constant cross section along its longitudinal extension—by the procedure described below, which presupposes a correspondingly designed slicing machine with a correspondingly designed automatic control.

The thickness adjustments for the slices are automatically calculated and preset by the control of the machine in such a way that the weight of the slices com-plies with the values given into the control system.

Unless otherwise stated, it is assumed in the following that the nominal weight indicated on the subsequent package and not a higher, internally determined, reference weight is selected and entered into the control system as the reference weight for slicing.

With regard to the method, it must first be determined how many slices with at least reference weight can be obtained from the loaf to be sliced, for which purpose first of all the total weight and/or total volume of the loaf should be determined, whereby due to an assumed always equal specific weight—at least for a batch of meat pieces—each of these two values can be calculated from the respective other value.

For this purpose, the loaf could simply be weighed before slicing and the maximum achievable number of slices with a certain reference weight calculated from this.

However, since such a loaf has an irregular shape in its initial state, and in particular does not have a constant cross section along its main extension direction, it would then additionally be necessary to know the cross section at each point along the loaf and to new determine and set the thickness of each slice leading to reach the reference weight.

To avoid this, the loaf is usually formed in a circumferentially closed forming tube whose forming tube cavity has a constant cross section over its entire length, at least in the longitudinal direction, e.g., by means of a longitudinal press stamp, in such a way that the loaf fills the inner cross section of the forming tube cavity as completely as possible at each longitudinal position and is formed into a uniform strand, i.e., a caliber which has the same cross section throughout its length. Knowing the cross-sectional area of the forming tube cavity and thus of the strand, it is then only necessary to determine the thickness of the slice in order to obtain a slice with a given weight, such as the reference weight.

The volume of the entire loaf can also be determined in this way, in that in the deformed state, i.e., when the deformed loaf already fills the cross section of the forming tube cavity over the entire length of the loaf, it is only necessary to determine the length of the loaf deformed into a strand or caliber. This can be done easily and automatically by determining the position of the longitudinal press stamp and knowing the position of the opposite stop, which usually lies directly against the cutting end, during longitudinal pressing.

Preferably, the loaf formed into a strand is subjected to a measuring force which, for example, is applied to the longitudinal extrusion punch, whereby this is preferably the same force with which the loaf is later pushed forward a defined distance beyond the front end of the forming tube between the cutting of the individual slices and, in particular, pressed against a stop.

The primary aim is to ensure that the individual slices do not become rejected due to underweight on the one hand and have as little excess weight as possible, e.g., compared to the reference weight, on the other hand, in order to keep the so-called giveaway, which is not paid for, as low as possible. Since the loaf does not have to be sliced without rests, an underweight residual slice can remain per loaf, which can then be used in a different way.

However, the first condition, which almost always applies, must be met: The average weight of all slices, e.g., of a batch of loaves, must also be above an externally specified tolerance lower limit, usually the nominal weight, either by the customer or by the legislator, otherwise the entire batch will be rejected.

Thus, the manufacturer will do everything possible to maintain this necessary average weight of all slices, and in parallel try to ensure that as few slices as possible have a weight below the external tolerance lower limit, whereby the individual slice would become waste.

The latter is a relatively small loss compared to the loss in the form of a whole batch, but it can still add up if, for example, one or two slices in each loaf become rejected due to such an underweight.

However, this is relatively easy without countermeasures, since the often pear-shaped or salmon-shaped loaves do not adapt optimally—at least not under the measuring force—to the internal contour of the forming tube cavity, especially in their initial and final areas, and cavities remain between the already approximately strand-shaped loaf and the forming tube cavity even in the pressed feed state, and then, assuming complete filling and corresponding determination of the slice thickness, the actual weight of the slice is below an expected target weight, e.g., the reference weight.

The manufacturer of the slices will either select the nominal weight as the reference weight, i.e., the weight of the individual slice indicated on the finished package, if only one single-slice portion is packed in the fixed package, or, for his own safety, select a somewhat higher weight as the reference weight, above all to ensure that the average weight is maintained over the entire batch.

Since, according to the invention, compliance with the average weight can also be achieved by other measures, it is assumed that the nominal weight is generally selected as the reference weight.

Based on this known procedure for the production of weight-accurate slices, an attempt is now made in accordance with the invention to fulfill the second condition, i.e., to avoid an underweight of individual slices as far as possible, in that, despite the same internal cross section over the length of the forming tube, the thickness adjustments for the individual slices are determined in such a way that their weight at least reaches or even exceeds an internally determined tolerance lower limit, but this internal tolerance lower limit is determined differently over the course of the loaf in the longitudinal direction.

Such an internal tolerance lower limit, i.e., defined by the manufacturer of the slices, can be the reference weight which all slices should have as a minimum. This reference weight—if it differs from the externally specified nominal weight—is also specified by the manufacturer of the slices and thus internally, but in strong dependence on the nominal weight.

The basic idea is to define different internal tolerance lower limits for the weight of the individual slices over the course of the loaf in its longitudinal direction, i.e., for the individual slices to be separated one after the other in this longitudinal direction, but in the same way for all loaves of a batch, since within a batch it is always a question of similar loaves, for example always the same piece of meat with regard to the position in the animals, and these therefore have approximately the same shape and consistency.

Accordingly, all the loaves in a batch have areas in the longitudinal direction of the loaf where there is a particularly high risk that, even if the slice thickness is the same for all the slices in the loaf, the slices produced in these areas will still have a weight below the internal tolerance lower limit.

In the case of a barrel-shaped or pear-shaped loaf in the initial state, these will be the starting area and end area, i.e., the first and last slices to be cut.

In the case of a more spindle-shaped loaf, these can also be the slices in the middle length area of the loaf, whereby such spindle-shaped initial forms rarely have to be sliced with weight accuracy.

In the case of the more common barrel-shaped or pear-shaped starting shapes, there is a risk in the first two or three slices and also in the last two or three slices that the loaf will not fully adhere to the inner circumferential surface of the forming tube up to its end face, while this risk is less in the middle length range of the loaf.

For this reason—in the case of barrel-shaped or pear-shaped loaves in the initial state—this internal tolerance lower limit in the center length area, the so-called center tolerance lower limit, is set lower than the internal tolerance lower limit at the beginning and end of the loaf, i.e., in the end areas of the loaf, which is therefore referred to as the internal end lower limit.

The center tolerance lower limit can in particular be the reference weight or only a little more.

In order to ensure that both end ranges of the loaves of a batch are not equally at risk, it would be important that all loaves are placed in the forming tube for slicing with the same orientation, for example with the thicker end first in the case of a pear shape, because it may be that the internal tolerance lower limit relative to the center range only needs to be changed at one of the two end ranges or needs to be changed differently in the two end ranges.

Especially when this cannot be ensured, or the qualitative and quantitative simi-larity of the loaves within a batch leaves much to be desired, the procedure according to the invention offers a safeguard against excessive scrap.

The relatively high boarder tolerance lower limit at the beginning and/or end of the loaf significantly reduces the risk of a slice there having a weight below the reference weight due to insufficient filling of the forming tube in this area.

Although there is a greater risk that such a slice will have a considerable excess weight, this loss of material is comparatively small with only one or two slices at the beginning and/or end of the loaf compared with the alternative of always having to produce a rejected slice due to underweight, especially at the beginning and end of the loaf.

Of course, this internal tolerance lower limit is also based on the reference weight and corresponds to this or is somewhat higher than the reference weight. Often, the internal tolerance lower limit is equal to or slightly higher than an externally specified tolerance lower limit, with such an externally specified tolerance lower limit being lower than the internally specified reference weight if the two differ.

With regard to the weight being slightly higher or slightly lower, this should mean in this context that it is a difference of no more than 5%, better no more than 4%, better no more than 3%, better no more than 2% compared to the externally specified tolerance lower limit.

This is because all internally specified weight limits serve only to meet the weight limits specified externally, i.e., by the customer or even by the legislator, but at the same time to avoid both overweight of the slices and, above all, scrap slices.

Preferably, the thickness adjustment for the first slice or the first slices or for the last slice or the last slices of the loaf, in particular of the first loaf of a batch, is either a thickness adjustment corresponding to the reference weight or a thickness adjustment corresponding to the thickness when the length of the loaf determined in the pressed state, in particular in the sliced state, is divided by the number of the maximum number of achievable slices previously determined therefrom.

In addition to the measures described above, which are aimed at avoiding underweight slices which therefore only form rejects, it is of course necessary to maintain the average weight at or above the nominal weight, which is more important from the point of view of the threat of damage.

A relatively simple method in view of control technology is to maintain the required average weight of the batch already within sub-areas of a batch, in particular within each individual sliced loaf or rolling over only a few, for example two successive, loaves, because if this is achieved for each sub-area or loaf, this condition is also fulfilled for the entire batch.

The disadvantage is that for compliance within a loaf, the compensation possi-bilities may be limited in order to comply with this condition for the entire loaf and thus, in total, more excess weight may occur over all loaves than when monitoring the condition of the required average weight independently of the individual loaves over the entire batch to be sliced.

For compliance per loaf, the actual weights of all sliced slices must first be determined as soon as possible after they have been produced, preferably in real time before they are removed, because only on the basis of this data can ap-propriate control be exercised for the thickness adjustments of the remaining slices of the loaf.

For this purpose, the actual weights of all slices already cut from a loaf are used to determine their average weight, and if this is below the limit serving as the target average weight, for example the reference weight or the nominal weight, measures are taken for the thickness adjustments of the slices still to be cut so that the specified target average weight, which is usually only specified for the entire batch of loaves, is likely to be mathematically achieved or even exceeded over all the slices of the loaf.

For this purpose, the reference weight or the internal tolerance lower limit is often increased accordingly for the rest of the slices of this loaf to be cut from the loaf, i.e., when the internal tolerance lower limit is changed, both its center tolerance lower limit and/or the boarder tolerance lower limit are increased.

For example, the boarder tolerance lower limit for the rear end of the loaf—i.e., the length range that is sliced last—can basically only be determined during the cutting of the loaf and depending on the determined actual weights of the slices already cut off from this loaf, which is most sensibly done only during the cutting of the second half of the loaf.

Preferably, the boarder tolerance lower limit for the rear end of the loaf can be continuously adjusted during slicing so that the required target average weight is achieved over all slices of the loaf.

The speed of weighing, the determination of the actual weight of the slices, the determination of the tolerance lower limit at least for the rear edge, etc., determine up to which slice to be cut the actual weights of the slices produced can still be taken into account for the determination of the edge tolerance lower limit for the rear end.

Also the center tolerance lower limit does not have to be a uniform value for the center area, but can even be determined differently from one slice to the next in the center area, preferably depending on the actual weights of the already produced and weighed slices from the loaf.

The analogous procedure can be carried out for the slices of the entire batch instead of for the slices of one batch, in which case the change of the thickness adjustments for the slices of the batch still to be separated is preferably carried out as a function of the determined average weight of the already separated slice of this batch, irrespective of whether the slices to be separated are slices from the end area or from the middle area.

Thus, for example, both the boarder tolerance lower limit and the center tolerance lower limit are changed in the same way for the future slices and loaves.

In order to build in a safety margin for compliance with the average weight—whether per loaf or for a partial batch or the entire batch—the increase in the reference weight and/or the internal tolerance lower limit carried out for this purpose is determined in such a way that, over the number of slices of the loaf or batch still to be cut—depending on the total over which the average weight is to be complied with—the shortfall weight accumulated to date is expected to be compensated and exceeded by at least 1%, preferably at least 2%, preferably at least 3%.

The verification of the previous average actual weight is checked several times during slicing, in particular after each further slice has been cut, and the reference weight and/or the internal tolerance lower limit is changed accordingly.

If the determination of the current average actual weight results in a too high average actual weight of the slices, the procedure is reversed.

In order to keep the excess weight—either per loaf or for the entire batch—within limits, the increase in the reference weight and/or the internal tolerance lower limit carried out for this purpose is capped in such a way that, via the number of slices of the loaf or batch still to be cut, the shortfall in weight accumulated so far is probably compensated for, but is not exceeded by more than 6%, better by no more than 5%, better by no more than 4%.

In order to be able to define thickness adjustments, in particular the internal tolerance lower limit, also for the first loaf of a batch, it is preferable to take into account empirical values from thickness adjustments and internal tolerance lower limits of previous batches of similar or identical loaves.

In this way, the thickness adjustments of all slices for individual slice numbers, which mathematically correspond to the desired reference weight and are uniform over the length of the loaf, can be changed, i.e., increased or decreased, according to the actual weights of the slices determined in previous batches of the same or similar slices.

It should also be clear that in the case of an external tolerance range, there is often only an external tolerance lower limit, but no external tolerance upper limit. In the case of internally specified weight limits, however, it may well make sense to also specify an internal tolerance upper limit, preferably again separately for the center range and the edge range, in order to keep the undesirable overweight of slice within limits.

In this case, either this external tolerance lower limit—which is generally below the nominal weight for the individual slices, since individual slices may well weigh somewhat less than the nominal weight indicated on the package, but not the entire batch—is selected as the reference weight, or, for safety reasons, a weight slightly above this, preferably also above the nominal weight,

Furthermore, it should be clear that in the case of spindle-shaped loaves, the procedure for center tolerance values and edge tolerance values should be ex-actly the reverse of that described above for barrel-shaped loaves.

The loaves of a batch can differ so much, especially with regard to their size, that different numbers of slices can be obtained from the individual loaves despite the same reference weight and/or nominal weight.

In this case, the number of slices forming the front and/or rear edge area is determined, usually a constant number over the entire batch, and all other slices are then considered and treated as belonging to the center area.

With regard to the slicing machine used for this purpose, the existing task is solved with a machine which is explained with reference to the following figures.

### BRIEF DESCRIPTION OF THE DRAWINGS

Embodiments according to the invention are shown in the following figures:

FIGS. 1a-d: a slicing machine in principle viewed from the side in different phases of slicing a loaf,

FIG. 2a, b: forming tubes in two parts in cross section in various operating states,

FIG. 3a: a pressed loaf in side view, with the slices to be made from it already sketched in,

FIG. 3b: a weight diagram over all slices of different loaves with weight adjustment relative to the reference weight,

FIG. 4a, b: diagrams internally and/or externally specified weight limits over the length of a loaf,

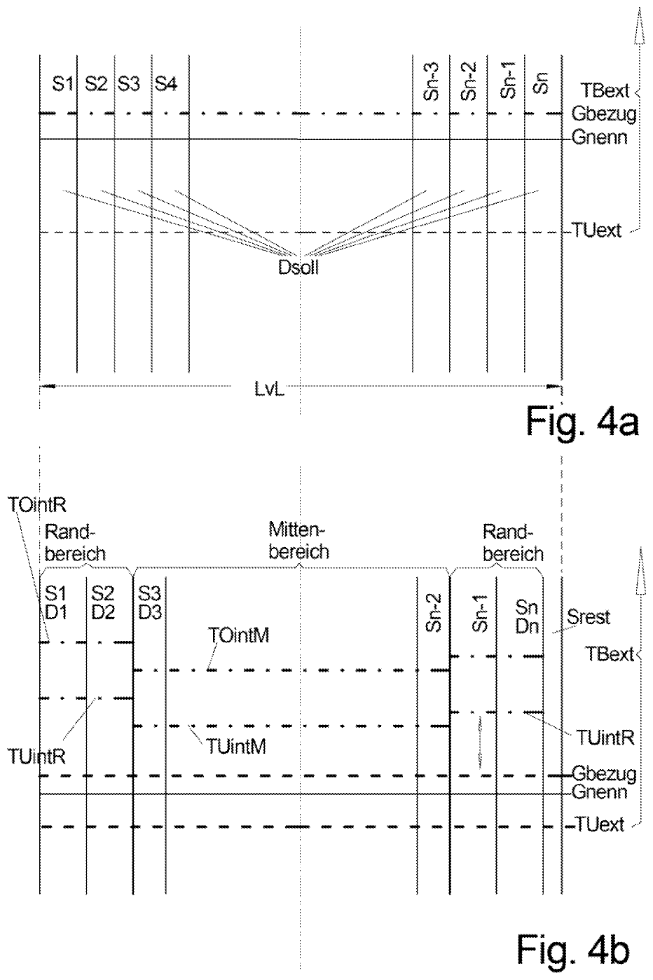

As FIG. 4a shows, the manufacturer of so-called fixed packages—i.e., of packaged foodstuffs with an imprinted nominal weight Gnenn, which is thus guaranteed to the purchaser—is given, on the one hand, the nominal weight Gnenn printed on the package and, on the other hand, an external tolerance lower limit TUext, as described above, usually the tolerance lower limit for individual slices.

For the control of the thickness adjustments D, it can preset itself a reference weight Gbezug to be kept, which is for example directly the nominal weight Gnenn. However, if the average of the actual weights Gist of all slices S1-Sn of a batch is only slightly below this nominal weight Gnenn, the entire batch of slices produced will be rejects.

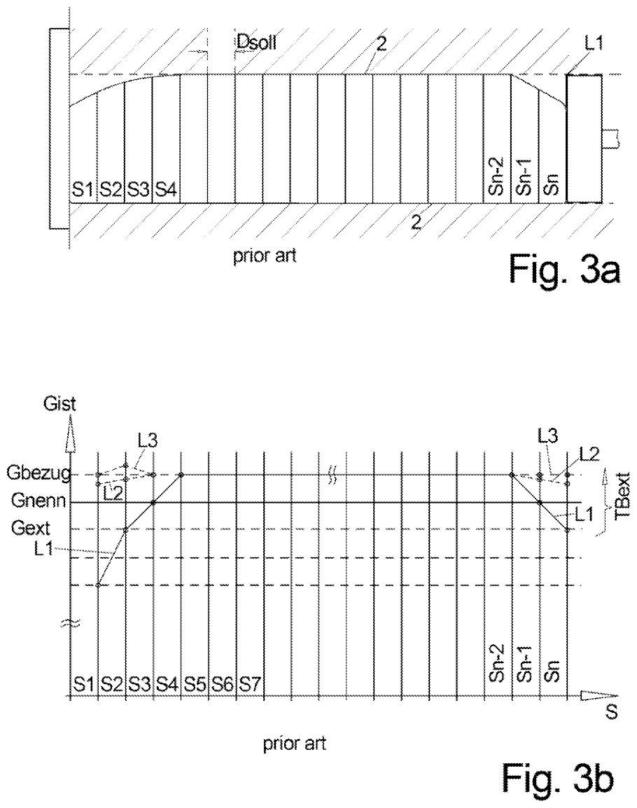

For this reason, a slightly higher weight than the nominal weight Gnenn is often chosen as the internally selected reference weight Gbezug, in order to minimize this risk, as shown in FIG. 3b and FIG. 4a, b. This is because, as FIG. 3a shows, the nominal weight Gnenn is not sufficient to fill the batch.

As FIG. 3a shows, even a loaf L1 pressed by a longitudinal press stamp 4 against a stop plate 13 does not always fill the cavity of the forming tube 2 as desired, especially at the beginning and end. If all the slices are then cut to the mathematically correct thickness adjustment Dsoll, which theoretically should result in at least the reference weight Gbezug, the first slices S1, S2, S3 and the last slices Sn-1, Sn would still have underweight.

As can be seen from FIG. 3b, in the past such underweight initial and final slices were accepted for the first loaf L1, but based on the actual weights of its slices, the thickness adjustments D1-Dn were corrected for the initial and final slices of the subsequent loaves L2, L3 in order to achieve that their weights are as far as possible already above the selected reference weight Gbezug for the second loaf L2, but not too far above it.

However, this is a complicated calculation and the success depends on several factors which also make the calculation of the correction values difficult, such as, for example, the number of the last sliced loaves already taken into account for the calculation or also the question of whether, within a batch of basically similar loaves, there can nevertheless be outliers in shape and weight which cannot be compensated for by taking previous loaves into account, and above all the frequency of such outliers.

According to the invention, a much simpler method is proposed as shown in FIG. 4b, which is also applicable in the case of relatively strong variations in shape and size of the loaves within a batch:

In order to ensure that the weight of the critical initial and final slices of a barrel-shaped or pear-shaped loaf in the unpressed state is very likely to be at least above the external tolerance lower limit TUext, preferably above the nominal weight Gnenn or even above the reference weight Gbezug, the manufacturer sets himself an internal tolerance lower limit TUint for the weight of the slices S1, S2 . . . , on the basis of which the thickness single slices are calculated. on the basis of which the thickness adjustments D1, D2 . . . for the slice S1, S2 . . . . are to be determined, namely an internal boarder tolerance lower limit TUintR for the critical edge areas—if the same is selected for both edge areas—and an internal center tolerance lower limit TUintM for the remaining center area of slice numbers in between.

The internal center tolerance lower limit TUintM is higher than the internal center tolerance lower limit TUintR, so that even if the forming tube cavity is not completely filled in these edge areas, the probability is high that a slice whose thickness adjustment is based on this internal tolerance lower limit will actually have an actual weight which is at least above the external tolerance lower limit TUext, perhaps even above the nominal weight Gnenn or even above the reference weight Gbezug.

Since the risk of the forming tube cavity 7 not being completely filled is much less great for the center area in the case of a barrel-shaped loaf in the initial state, this internal center tolerance lower limit TUintM can be selected lower than the edge tolerance lower limit TUintR without great risk that the slices produced from this center area will be below the lowest weight threshold, the external tolerance lower limit TUext.

The internal center tolerance lower limit TUintM does not even necessarily have to be above the reference weight Gbezug and/or above the nominal weight Gnenn, but can even be just below it, as long as it is only above the external tolerance lower limit TUext.

In this way, the originally theoretically calculated number of slices that can be obtained from one loaf and that comply with the weight conditions can often be achieved.

Depending on the shape of the unpressed loaf, e.g., in the case of a strongly pear-shaped loaf, it may also be useful to set the internal boarder tolerance lower limits TUintR separately and differently for the front end and the rear end, i.e., in FIG. 4b the left and right end areas.

On the other hand, to avoid excessive overweights of the individual slices, the slice manufacturer can additionally set an internal tolerance upper limit TOintR and select the thickness adjustments in such a way that this internal tolerance upper limit TOintR is unlikely to be reached or even exceeded.

FIG. 4b also shows that the slices S1 to Sn produced by this method can have slightly lower thickness adjustments D1, D2 . . . , at least in the middle area, than slices whose calculated thickness adjustment Dsoll according to FIG. 4a is the same for all slices S1 to Sn and is selected in such a way that the total length LvL of the longitudinally pressed loaf is divided only by the maximum number Sn to be obtained of slices which have at least the reference weight Gbezug.

As a result, with the procedure according to the invention, and even if the slice thickness in the edge areas was greater than the calculated thickness adjustment Dsoll, a residual slice Srest can remain—over and above the calculated number of non-underweight slices—whose weight is below all limit values, The weight of this slice is below all limit values, presumably also below the external tolerance lower limit TUext, but can be used separately and against payment by the manufacturer of the slices, whereas if the length LvL were distributed among the individual weight-correct, attainable slices S1 to Sn of a loaf L as shown in FIG. 4a, this would represent a non-remunerated giveaway.

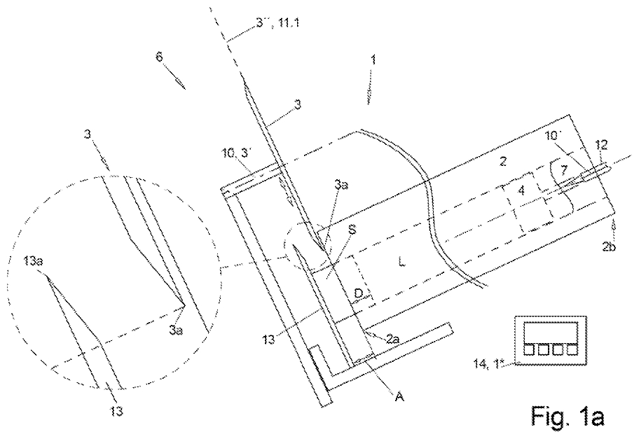

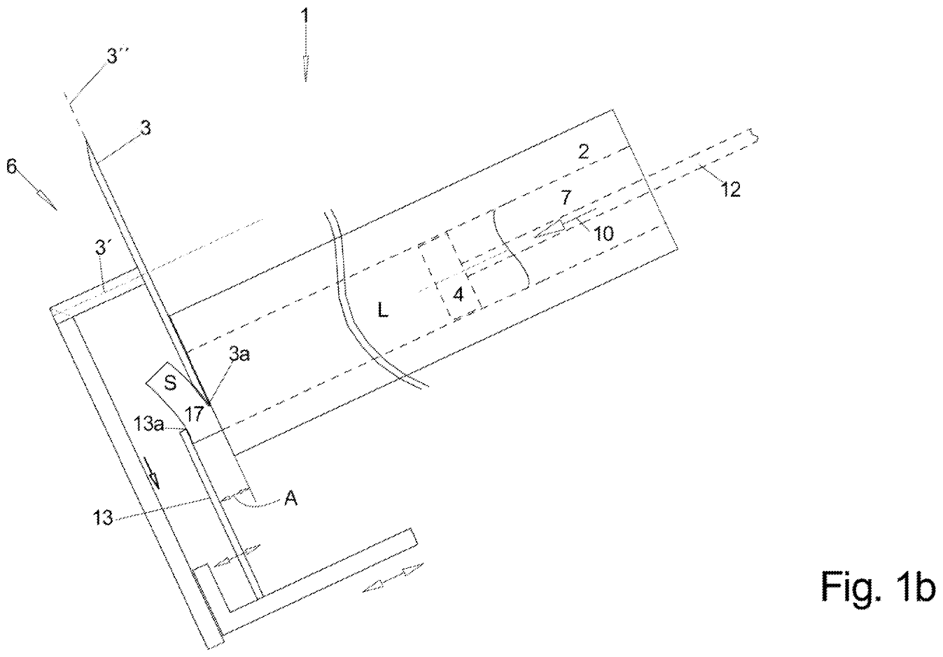

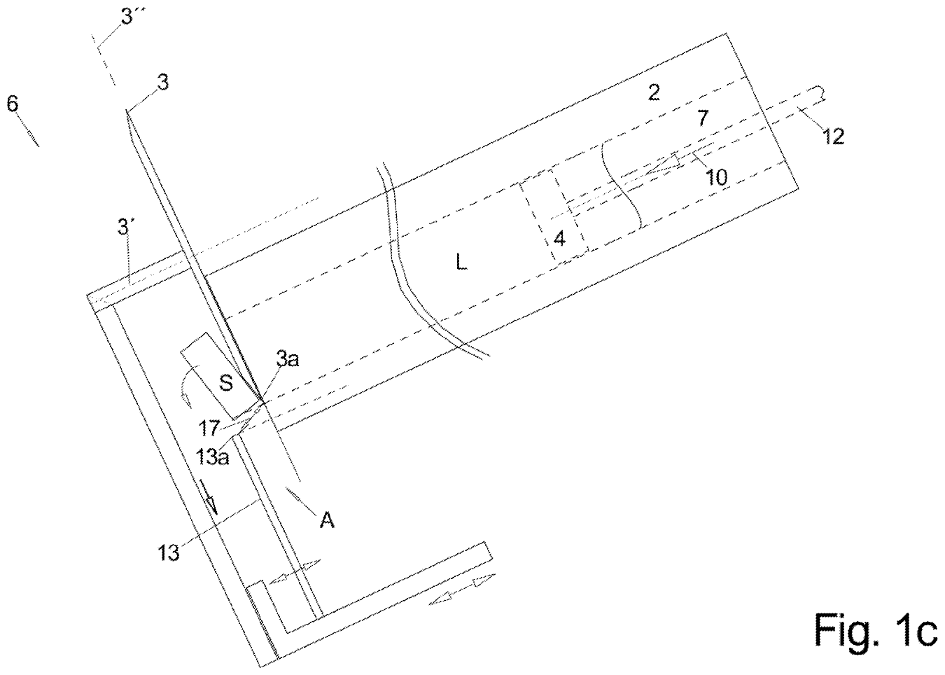

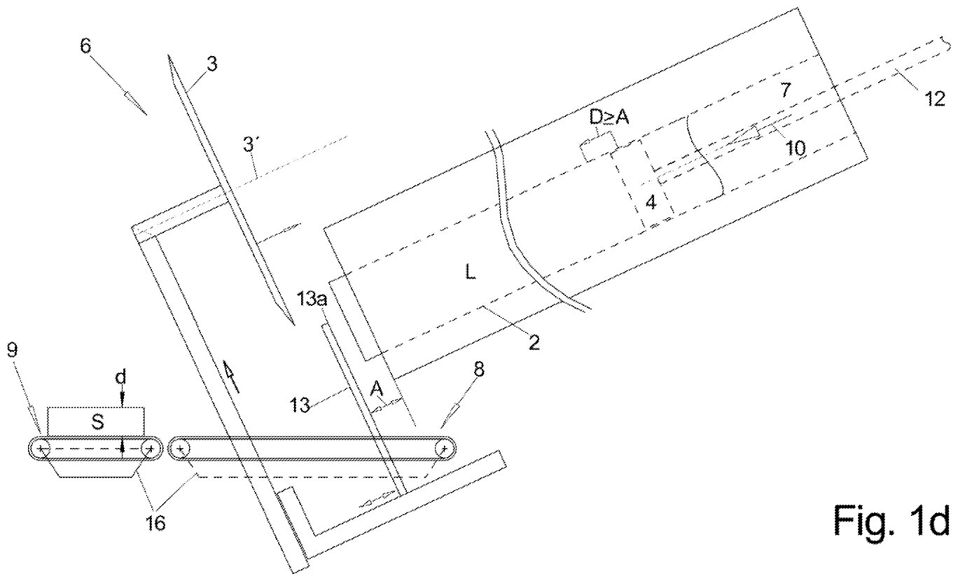

With regard to the slicing machine 1 shown in rudimentary form in FIGS. 1a to 1d for cutting slices S from loaves L one after the other, in particular using the method described, such a slicing machine 1 comprises on the one hand a holding device 2 for the loaf L to be sliced.

The holding device 2 is here a forming tube 2 which is circumferentially closed and open at the end faces, with a cross section of its internal space 7 which remains constant over its entire length.

Furthermore, the slicing machine 1 comprises a cutting unit 6, in which in particular a circular disc-shaped or sickle-shaped blade 3 rotating about a blade axis 3′ cuts off from the front end of the loaf L a slice S projecting from the cutting end 2a of the forming tube 2, as well as a control 1* which controls all moving parts of the slicing machine 1.

According to the invention, the control 1* is embodied to be able to perform the slicing machine 1 according to the described procedure for varying the weight of the slices S.

Preferably, the slicing machine 1 comprises, in addition to the forming tube 2, a longitudinal press stamp 4 for pressing the loaf L in the longitudinal direction 10, which can be moved from the rear open end, the loading end 2b, into the internal space 7 of the forming tube 2 with a precise fit and is attached to the front end of a piston rod 12, until the longitudinal press stamp fills the internal space 7 remaining in front of the longitudinal press stamp 4 as completely as possible and also has a cross section which is uniform over its entire length and corresponds to the cross section of the internal space 7.

Furthermore, there is usually a stop plate 13 for the loaf L pushed out of the forming tube 2 towards the front by means of the longitudinal press stamp 4, the distance A of which to the front end, the cutting end 2a of the forming tube 2, can be adjusted.

The stop plate 13 can also serve as a front stop when the loaf L is pressed longitudinally in the forming tube 2 by the longitudinal press stamp 4 when it is moved completely up to the front end face of the forming tube 2.

The blade 3, on the other hand, is usually moved back and forth at a longitudinal position that is always the same, in particular relative to the forming tube 2, in particular directly at the front end face of the forming tube 2, e.g., in a 1st transverse direction 11.1, and thus in each case cuts off a slice S from the loaf L that has in the meantime been pushed forward again as far as the stop plate 13.

As can be seen from the sequence of FIGS. 1a to 1d, before the loaf L is contacted by the cutting edge 3a of the blade 3, the cover plate 13—viewed in the longitudinal direction 10—covers the entire cross section of the forming tube 2 and, as the cutting edge 3a of the blade 3 increasingly plunges into the loaf L, moves together with the latter, e.g., in this first transverse direction 11.1 in this first transverse direction 11.1, so that the slice S pushing through the gap 17 between the cutting edge 3a and the functional edge 13a of the stop plate 13 can finally tip down over this upper edge 13a—which may or may not be bev-eled—of the stop plate 13 and fall onto the conveyor 8, as can be seen in FIGS. 1b and 1c.

The blade 3 and stop plate 13 then move back against the direction of immer-sion, i.e., in the transverse direction 11.1, as shown in FIG. 1d, and the loaf L is again pushed out over the front cutting end 2a of the forming tube 2 until it comes to rest against the stop plate 13, which is set to the desired distance A, in particular the thickness adjustment D, again covering the entire cross section of the inner forming cavity 7 as viewed in the longitudinal direction 10.

As best shown by the enlargement of FIG. 1a, stop plate 13 and blade 3, viewed in longitudinal direction 10, can overlap slightly when viewed in side view transversely to the direction of insertion 11.1, if it is ensured by corresponding slanted the edge regions facing each other that the gap 17 remaining between them is large enough for the cut-off slice S to move through the gap 17.

A slicing machine 1 of this type also has a scale 16—see FIG. 1d—which de-termines the actual weight Gist of each sliced slice S individually, and an operating unit 14—see FIG. 1a—with which, in particular, on the one hand the feed distance by which the longitudinal press stamp 4 pushes the loaf L for-wards can be set before the next slice is sliced. On the other hand, based on this, the distance A of the stop plate 13 to the axial position at which the blade 3 is located when a slice S is cut off can also be set, manually and in particular automatically by the control 1*.

The thickness adjustment D to be determined before a slice S is cut off is this feed distance, whereby the feed distance is generally not only just as large, but somewhat larger than the set distance A, but both parameters influence the subsequent weight Gist of the cut-off slice S. The slice S is then cut off at the same time.

However, the scale 16 is usually not located under the conveyor 8 onto which the separated slice S falls directly, since the vibrations caused by the impact of the fallen slice make it very difficult to determine the exact weight, but as a rule only under the further conveyor 9 immediately following it.

If technically possible, however, weighing should be carried out as far upstream as possible and immediately after the slice S has been cut off, i.e., in particular immediately after it has hit the conveyor 8, because the weight Gist of the slice S which has just been cut off should be known as early as possible in order to be able to influence the thickness adjustments D of slice S to be cut off thereaf-ter as quickly as possible.

The loaf L can be pressed not only in the longitudinal direction 10 by a longitudinal press stamp 4, but also—preferably before or at the same time—by a cross press stamp 5 in one of the transverse directions, preferably also the first transverse direction 11.1, in which the blade 3 moves during cutting.

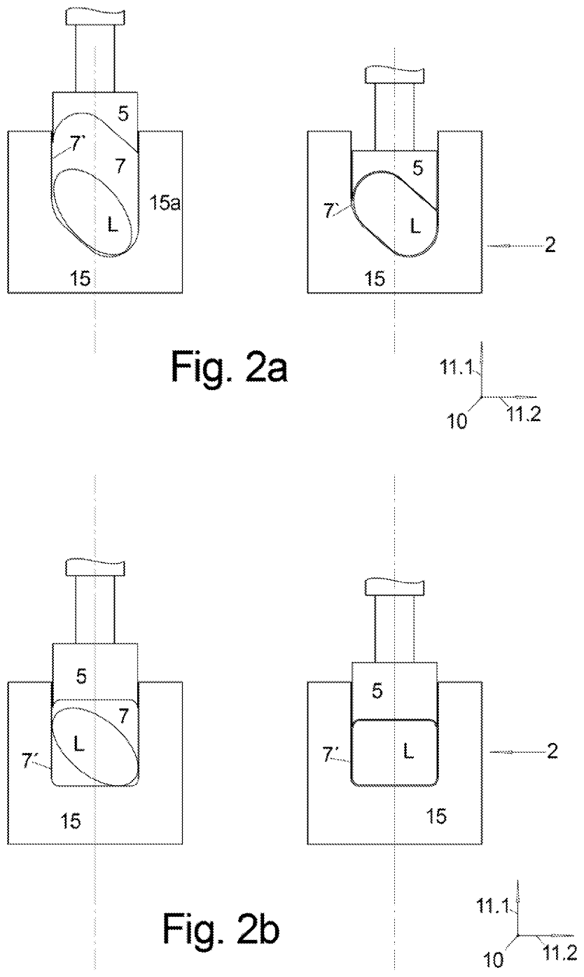

Corresponding formations of forming tubes 2—viewed in the longitudinal direction 10—are shown in FIG. 2a, b.

The forming tube 2 viewed in the longitudinal direction 10 consists of two components in the circumferential direction, namely a transverse press rim 15 which is U-shaped in this viewing direction and into the open side of which a transverse press stamp 5 is inserted in a transverse direction, preferably the first transverse direction 11.1, and presses the previously inserted loaf L, which has an approximately elliptical cross section in the unpressed initial state, in this transverse direction 11.1 until it at least partially assumes a cross section corresponding to the cross section 7′ of the remaining internal space 7 in the forming tube 2.

The cross press stamp 5 can thereby be advanced to a fixed transverse position so that the cross section 7′ of the internal space 7 in the forming tube 2 then coincides with the front surface 4a of the longitudinal press stamp 4, which can then have a shape and size that cannot be changed.

Preferably, however, the cross press stamp 5 is force-controlled so that its final pressing position is not fixed. In this case, the longitudinal press stamp 4 must have a variable cross section in the direction of movement of the cross press stamp 5, which automatically adapts to the cross section 7′ of the momentary interior 7 of the forming tube 2.

Whereas in FIG. 2b the internal space 7 of the transverse press rim 15 has a cross section 7′ which is approximately rectangular in shape with rounded edges, in FIG. 2a the internal space 7 has a cross section 7′ which has a strongly rounded and sloping bottom compared to the lower side wall 15a of the transverse press rim 15, while the front surface of the cross press stamp 5 has an analogously opposing contour, so that this results in an oblique, approximately parallelogram-shaped or slot-shaped inner cross section 7′ with rounded edges in the closed forming tube 2.

Such a cross section 7′ of the internal space 7 comes closer to the usually elliptical initial cross section of the loaf L than a rectangular cross section and re-quires less transverse compression than with the cross section shape 7′ according to FIG. 2b, in which the width of the internal space 7 is usually selected to be smaller than the greatest extension of the approximately elliptical cross section of the unpressed loaf L.

The control 1* is signal-technically connected with the scale 16, with the operating unit 14 and likewise with the drives of all existing pressing stamps 4, 5 as well as the drives for the cutting unit 6, in particular the blade, 3, so that all movements of the slicing machine 1 can be automatically controlled by the control 1*.

### REFERENCE LIST

1 cutting machine
1* control
2 forming tube, holding device
2a cutting end
2b loading end
3 blade
3′ blade axis
3″ blade plane
3a cutting edge
4 longitudinal press stamp
5 cross press stamp
6 cutting unit
7 forming tube cavity, internal space
7′ cross section
8 conveyor
9 conveyor
10 longitudinal direction, axial direction,
10′ feed direction
11 transverse direction
11.1 first transverse direction
11.2 second transverse direction
12 piston rod
13 stop plate
13a functional edge, upper edge
14 operating unit
15 transverse press rim
16 scale
17 gap
A distance
D, D1-Dn thickness adjustment of individual slices
Dsoll calculated thickness adjustment
d slice thickness
Gbezug reference weight
Gist actual weight
Gnenn nominal weight
L, L1 to Lz loaf
LvL longitudinal pressed loaf
S, S1 to Sn slice
TBext tolerance range
TUext tolerance lower limit
TBint tolerance range
TUint tolerance lower limit
TOint tolerance upper limit
TUintM center tolerance lower limit
TOintM center tolerance upper limit
TUintR end tolerance lower limit
TOintR end tolerance Upper Limit

1. A method for at least achieving a reference weight of as many individual slices as possible when slicing a batch of loaves into slices, by automatically varying thickness for the slices to be sliced, wherein
A) each loaf is arranged in a holding device for holding the loaf and advancing the loaf during slicing in a feed direction
B) weight or volume of a respective loaf is determined,
C) maximum number of such slices that can be produced from this loaf with at least reference weight is calculated from this,
D) predetermined thickness adjustments are calculated for these individual slices of this loaf, at which actual weight of each slice should at least correspond to the reference weight and wherein
E) the thickness adjustments for the individual slices of this loaf are determined in such a way that the actual weights of the individual slices are expected to reach a tolerance lower limit defined internally as a function of the reference weight, and
F) the internal tolerance lower limit is set differently over the course of the loaf in the feed direction.

2. The method according to claim 1, wherein
in step A) each loaf is received in a circumferentially closed forming tube as the holding device under a measuring pressure with a cross section of a cavity of the forming tube which is constant over an entire length,
in step B), the weight or the volume of the respective loaf received therein is determined from a determined length and cross section of that part of the forming tube cavity which, in particular, is under the measuring pressure.

3. The method according to claim 1, wherein
the internal tolerance lower limit in a middle part of the loaf as a center tolerance lower limit is set lower than a boarder tolerance lower limit in at least one of front or rear end regions of the loaf
or vice versa.

4. The method according to claim 1, wherein
the internal tolerance lower limit is equal to or higher than the reference weight, and/or
the internal tolerance lower limit is equal to or higher than an external tolerance lower limit, which in particular is lower than the reference weight.

5. The method according to claim 1, wherein
as thickness adjustments for a 1st slice or first slices of the loaf are selected
either a thickness adjustment is selected corresponding to the reference weight
or a thickness adjustment is selected corresponding to a length of the loaf divided by maximum number of slices with reference weight obtainable from this loaf.

6. The method according to claim 1,
in which, as average over a loaf, a predetermined nominal weight and/or reference weight is to be achieved, wherein
the actual weight of the previously separated slices of the loaves of the batch is determined,
average weight is determined from the actual weights of all slices of the loaf already produced, and if this lies below the previous reference weight and/or the nominal weight, measures are taken for the slices still to be cut off to increase their average weight in such a way that by calculation the average weight of all slices of this loaf is expected to at least reach the reference weight and/or the nominal weight,
in particular by increasing the previous reference weight and/or the previous tolerance lower limit for the rest of the slices of this loaf.

7. The method according to claim 3, wherein
the boarder tolerance lower limit for the rear end region of the loaf is determined only during cutting of this loaf depending on the actual weights of the slices separated from this loaf so far,
in particular during the slicing of the second half of the loaf,
in particular during the slicing of the middle part of the loaf.

8. The method according to claim 1,
in which, as average over the batch of loaves, the predetermined reference weight and/or nominal weight is to be achieved, wherein
the actual weight of each separated slice of the loaves of the batch is determined,
average weight is determined from the actual weights of all the slices already produced in a batch and, if this is below the previous reference weight and/or the nominal weight, measures are taken for the loaves still to be sliced to increase the average weight of the slices still to be sliced so that by calculation the average weight of all the slices in this batch is expected to at least reach the reference weight and/or the nominal weight,
in particular by increasing the previous reference weight and/or the tolerance lower limit for the remainder of the batch.

9. The method according to claim 8, wherein
the increase of the previous reference weight and/or of the tolerance lower limit is selected in such a way that this increase over the number of slices of this loaf or of this batch still to be cut off compensates for the previously accumulated shortfall weight or exceeds it by at least 1%,
in particular a check as to whether this condition is mathematically expected to be complied with is checked several times during the cutting of the remaining slices, in particular after the cutting of each further slice, and in a case of a negative result of the check the increase in the previous reference weight and/or tolerance lower limit is increased in such a way that the required average weight of the slices over the entire loaf or the entire batch is mathematically expected to be achieved by the end.

10. The method according to claim 8, wherein
the increase of the previous reference weight and/or the previous tolerance lower limit is chosen in such a way that this increase over the number of slices still to be cut exceeds the previously accumulated shortfall weight, but by no more than 6%,
a check as to whether this condition is expected to be met mathematically is carried out several times during the cutting of the remaining slices, in particular after the cutting of each further slice, and if the result of the check is negative, the increase in the previous reference weight and/or tolerance lower limit is reduced in such a way that the required average weight of the loaf or of the batch is expected to be met mathematically by the end.

11. The method according to claim 1, wherein
before slicing a first loaf of a batch of loaves,
for thickness adjustments to be specified for the individual slices of this first loaf, experience values from determined thickness adjustments of previous batches are taken into account,
in particular the slice adjustment of all slices for individual slice numbers corresponding to a desired reference weight and uniform over the entire loaf is increased or decreased in accordance with the actual weights thus achieved in previous batches.

12. The method according to claim 1,
wherein the reference weight lies within an externally predefined tolerance range with a tolerance lower limit, wherein
the external tolerance lower limit of the external tolerance range is selected as the reference weight.

13. The method according to claim 1, wherein
a weight is selected as the reference weight which is a nominal weight or up to 10% above it.

14. The method according to claim 1,
wherein pressed loaves of a batch allow a different number of maximum obtainable slices having the reference weight, wherein
number of slices comprising front and/or rear end area is fixed, and
all other slices are treated as a middle area.

15. A slicing machine for slicing loaves into slices with an actual weight of as many individual slices as possible on or above a reference weight by varying thickness adjustments for the slices to be sliced, comprising
a holding device for holding a loaf to be sliced,
a cutting unit for cutting slices from the loaf to be sliced, the cutting unit being controllable with respect to a thickness adjustment for parameters influencing actual weight of a slice to be cut,
a scale for automatic weighing of all separated slices,
a control which controls all movable components of the device, wherein
the control is capable of performing the method according to claim 1.
